(19) United States
(12) Patent Application Publication
(10) Pub. No.: US 2008/0170540 A1
(43) Pub. Date: Jul. 17, 2008

(54) COMMUNICATION SYSTEM, COMMUNICATION DEVICE, AND COMMUNICATION METHOD

(75) Inventor: Kunio Fukuda, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/972,416

(22) Filed: Jan. 10, 2008

(30) Foreign Application Priority Data
Jan. 17, 2007 (JP) 2007-008046

(51) Int. Cl. H04Q 7/00

(52) U.S. Cl. 370/328

(57) ABSTRACT

Disclosed herein a communication system in which communicating stations are interconnected via a first transmission path and a second transmission path, the communication system including: a data transmitting station for dividing one piece of transmission data to generate two data packets, assigning the data packets to the first transmission path and the second transmission path, and transmitting each data packet; and a data receiving station for receiving the data packets from the data transmitting station via the first transmission path and the second transmission path, obtaining the original transmission data by combining the data packets assigned to the respective transmission paths with each other, and transmitting a packet including a response to reception of the data packets from the first transmission path and the second transmission path simultaneously.

### CROSS REFERENCES TO RELATED APPLICATIONS

The present application claims priority to Japanese Patent Application JP 20074-08046 filed in the Japan Patent Office on Jan. 17, 2007, the entire contents of which being incorporated herein by reference.

### BACKGROUND

The present application relates to a communication system, a communication device, and a communication method using power line communication, and particularly to a communication system, a communication device, and a communication method simultaneously using both a wireless transmission path and a power line communication path.

More specifically, the present application relates to a communication system, a communication device, and a communication method for achieving a desired communication speed and a desired communication quality, in each of a wireless transmission path and a power line communication path by a transmission form corresponding to communication conditions, using both the transmission paths simultaneously, and particularly to a communication system, a communication device, and a communication method for achieving a high-speed communication in a transmission path used to transmit a data packet mainly of contents or the like and securing a communication quality in a transmission path used to transmit a response packet of an ACK/NACK or the like.

A wireless network is drawing attention as a system for achieving freedom from wiring in an existing wire communication system. Systems now used principally by wireless LANs for home use are IEEE802.11a using a 5.2 GHz band for carrier frequency and IEEE802.11b/g using a 2.4 GHz band for carrier frequency. For example, IEEE802.11a/g uses an OFDM (Orthogonal Frequency Division Multiplexing) modulation system, which is one of multicarrier systems, as a wireless LAN standard. In the OFDM modulation system, transmitting data is distributed to a plurality of carriers to which frequencies orthogonal to each other are set, and then transmitted. Being orthogonal to each other means that a peak point of a spectrum of an arbitrary subcarrier always coincides with a zero point of a spectrum of another subcarrier.

Hence, because transmitting data is distributed to a plurality of carriers having different frequencies and then transmitted, there are features of a narrow band of each of the carriers, a very high efficiency of frequency use, and insusceptibility to frequency selective fading interference.

These IEEE802.11a and IEEE802.11g systems have a data transmission speed of 54 Mbps at a maximum in a physical layer, a data transmission speed of a little less than 30 Mbps at a maximum in a MAC (Media Access Control) layer, and an effective speed of about 20 Mbps at a maximum in TCP (Transport Control Protocol) transmission. However, it is considered that a communication system for achieving a faster transmission speed may be required with increases in amount of data information handled in the world. In addition, radio communication technology generally has a problem in that a radio signal tends to be affected by interference of another system using a same frequency channel or a communication cannot be performed between rooms because the radio signal does not easily pass through walls.

On the other hand, power line communication (PLC) is known in which a device supplied with power via the power line and having a communicating function superimposes a communication signal on a power line and thereby communication is performed via the power line between the device and another device having a similar function. The power line communication enables communication to be performed between devices in rooms provided with an AC outlet, and does not impose a limitation on the location of the destination device A communication system using the power line communication does not require the installation of new communication lines by using existing power lines, and is able to achieve a high-speed communication at 100 Mbps or more.

However, the communication system using the power line communication has problems of behaving differently depending on the structure of a house in which communication is performed, and tending to be affected by a noise caused by a life rhythm (for example a noise caused by the insertion or removal of a cord or by the use of a hair drier).

Accordingly, a hybrid communication system has been proposed which uses both a wireless transmission path and a power line communication path, and selects or combines the transmission paths, whereby an efficient transmission is achieved while the transmission paths are complemented with each other in communication quality by a transmission form corresponding to communication conditions (see Japanese Patent Laid-Open No. 2006-109022 (Patent Document 1), for example).

The existing hybrid communication system combines the transmission paths with each other in communications in both directions, and therefore uniformizes communication qualities and communication capacities in the respective directions. However, when the communication system is used for Internet access from home or an application for moving image streaming or the like, communication in a down direction from a server as an information distributor to a client as an information receiver is desired to have a high speed, whereas transmission in an up direction is not desired to have such a high speed. In the latter communication in the up direction, communication quality rather than communication speed is important, and a controlling packet including a response such as an ACK/NACK or the like is desired to be delivered reliably.

### SUMMARY

It is desirable to provide a communication system, a communication device, a communication method that can achieve a desired communication speed and a desired communication quality in each of an up direction and a down direction by a transmission form corresponding to communication conditions, using both a wireless transmission path and a power line communication path simultaneously.

Specifically, it is desirable to provide a communication system, a communication device, and a communication method that can achieve a high-speed communication in a transmission path used to transmit a data packet mainly of contents or the like and secure a communication quality in a transmission path used to transmit a response packet of an ACK/NACK or the like.

According to an embodiment, there is provided-a communication system in which communicating stations are interconnected via a first transmission path and a second transmission path, the communication system including: a data transmitting station for dividing one piece of transmission data to generate two data packets, assigning the data packets to the first transmission path and the second transmission path, and transmitting each data packet, and a data receiving station for receiving the data packets from the data transmitting a station via the first transmission path and the second transmission path, obtaining the original transmission data by combining the data packets assigned to the respective transmission paths with each other, and transmitting a packet including a response to reception of the data packets from the first transmission path and the second transmission path simultaneously.

The system described above refers to a logical set of a plurality of apparatuses (or functional modules for realizing specific functions) regardless of whether each apparatus or functional module is present within a single casing (the same is true in the following).

In addition, while the first transmission path and the second transmission path described above are a combination of a transmission path formed by radio and a transmission path using a power line, for example, the spirit of the present application is not necessarily limited to this. For example, a hybrid communication system can be formed with a combination of arbitrary transmission paths in different frequency bands for use.

Recently, radio communication technology including wireless LAN technology and the like has spread rapidly. However, the radio communication technology has a problem in that a radio signal tends to be affected by interference of another system using a same frequency channel or a communication cannot be performed between rooms because the radio signal does not easily pass through walls.

On the other hand, power line communication in which communication is performed via a power line is known. The power line communication enables communication to be performed between devices in rooms provided with an AC outlet, and is able to achieve-a high-speed communication at 100 Mbps or more. However, a communication system using the power line communication has problems of behaving differently depending on the structure of a house in which communication is performed, and tends to be affected by a noise caused by a life rhythm.

The communication system according to the above-described embodiment simultaneously uses both a wireless transmission path and a power line communication path, and selects or combines the transmission paths. Thereby, high-speed communication is enabled according to a transmission form or communication conditions, and an efficient transmission is achieved while communication quality is secured.

When the communication system is used for Internet access from home or an application for moving image streaming or the like, communication in a down direction from a server as an information distributor to a client as an information receiver is desired to have a high speed. On the other hand, transmission in an up direction is not desired to have such a high speed, but rather communication quality is important. The transmission in the up direction is desired to reliably deliver a controlling packet of an ACK/NACK or the like.

Accordingly, in the communication system according to the above-described embodiment, the data transmitting station such as a base station or the like divides one piece of transmission data to generate two data packets, assigns the data packets to the first transmission path and the second transmission path, and then transmits each data packet. Thus, communication speed is increased as compared with a case of using only one of the transmission paths. The communication system is therefore suitable for applications required of isochronism, such as high-capacity data transmission, moving image streaming and the like.

On the other hand, the data receiving station side such as a terminal station or the like receives the data packets via the first transmission path and the second transmission path, and combines the data packets allocated to the respective transmission paths with each other, so that the original transmitting data can be obtained. The data receiving station further transmits as packet including a-response to the reception of the data packets from the first transmission path and the second transmission path simultaneously. Thus, even under a condition where the communication quality of one of the transmission paths deteriorates, the transmission path is complemented by the other transmission path, so that a constant communication quality can be ensured. It is therefore possible to reliably deliver a controlling packet including a response such as an ACK/NACK or the like to the data transmitting station side.

Thus, the communication system according to the above-described embodiment can achieve a desired communication speed and a desired communication quality in each of an up direction and a down direction by a transmission form corresponding to communication conditions, using both a wireless transmission path and a power line communication path simultaneously.

In the communication system according to the above-described embodiment, the data transmitting station serving as a data packet transmitting side such as a base station or the like may determine communication quality, and perform packet transmission processing in one of operation modes according to a result of the determination, the operation modes being a high-speed transmission mode in which transmitting packets are assigned to respective transmission paths and transmitted and a high-quality transmission mode in which a same transmitting packet is simultaneously transmitted to each transmission path.

Thus, in transmitting a data packet in the down direction, the data transmitting station can achieve a desired communication speed and a desired communication quality in each of the up direction and the down direction by a transmission form corresponding to communication conditions.

The data transmitting station can determine the communication quality of each transmission path on a basis of a response returned from the data receiving station, for example. Specifically, the data transmitting station can detect degradation in communication quality in the down direction according to a fact that frequency of failure to receive a response to transmission of a data packet has exceeded a predetermined reference or a fact that response reception has failed a predetermined number of consecutive times. In such a case, the data transmitting station makes a transition from the highspeed transmission mode to data packet transmitting operation in the high-quality transmission mode to secure a communication, quality. It is thereby possible to suppress a transmission error and a decrease in throughput attendant on layer processing at that time.

In addition, the data transmitting station can detect restoration of a communication quality in the down direction according to a fact that frequency of failure to receive a response to transmission of a data packet has become lower than a predetermined reference or a fact that response reception has succeeded a predetermined number of consecutive times. In such a case, the data transmitting station returns to transmitting operation in the high-speed transmission mode to thereby achieve a high-speed communication.

According to an embodiment, it is possible to provide a communication system, a communication device, and a communication method that can achieve a desired communication speed and a desired communication quality in each of an up direction and a down direction by a transmission form corresponding to communication conditions, using both a wireless transmission path and a power line communication path simultaneously.

In addition, according to an embodiment, it is possible to provide a communication system, a communication device, and a communication method that can achieve a high-speed communication in a transmission path used to transmit a data packet mainly of contents or the like and secure a communication quality in a transmission path used to transmit a controlling packet including a response such as an ACK/NACK or the like.

Further, according to an embodiment, by using different kinds of transmission paths simultaneously, a path is made to diverge, so that a data leakage by wiretapping can be prevented.

Additional features and advantages are described herein, and will be apparent from, the following Detailed Description and the figures.

### BRIEF DESCRIPTION OF THE FIGURES

FIG. 1 is a diagram schematically showing a configuration of a communication system according to an embodiment;

FIG. 2A is a diagram showing a state in which transmitting packets are distributed to a transmission path A and a transmission path B at a time of downstream transmission;

FIG. 2B is a diagram showing a state tin which transmitting packets are distributed to a transmission path A and a transmission path B at a time of upstream transmission;

FIG. 3 is a diagram; showing an example of configuration of a communication device that can operate as a base station or a terminal station in the communication system according to an embodiment;

FIG. 4 is a diagram showing an example of internal configuration of a receiving unit in the communication device shown in FIG. 3;

FIG. 5 is a diagram showing an example of internal configuration of a transmitting unit in the communication device shown in FIG. 3;

FIG. 6 is a diagram showing a functional configuration of a data transmission controlling function within a communication control unit of the communication device shown in FIG. 3;

FIG. 7 is a diagram showing a functional configuration of a data reception controlling function within the communication control unit of the communication device shown in FIG. 3;

FIG. 8 is a diagram showing an example of frame configuration of a data packet used in the communication system according to an embodiment;

FIG. 9 is a diagram showing a state in which data to be transferred is divided into two pieces of data, which are distributed to transmitting packets for respective frequency bands A and B (or the respective transmission paths A and B) and then transmitted;

FIG. 10 is a diagram showing an example of frame configuration of a control packet used to return a response in the communication system according to an embodiment;

FIG. 11 is a diagram showing an example of a communicating operation sequence in which the transmission of data packets and the returning of response packets in response to the data packets are performed between a terminal station and a base station in the communication system according to an embodiment;

FIG. 12 is a diagram showing another example of a communicating operation sequence in which the transmission of data packets and the returning of response packets in response to the data packets are performed between a terminal station and a base station in the communication system according to an embodiment;

FIG. 13 is a flowchart showing a processing procedure for the communication device according to an embodiment to operate as a base station; and

FIG. 14 is a flowchart showing a processing procedure for the communication device according to an embodiment to operate as a terminal station.

### DETAILED DESCRIPTION

The present application will be explained in detail with reference to the drawings according to embodiments.

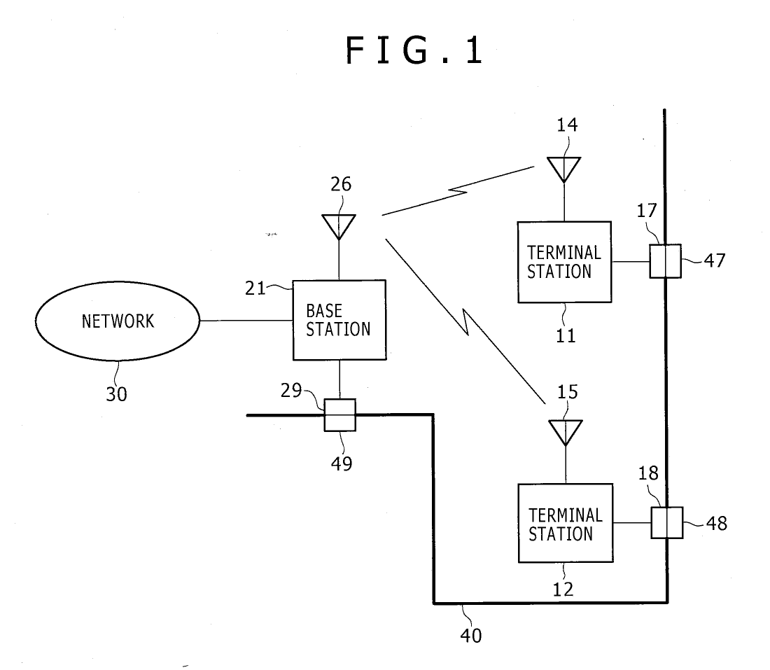

FIG. 1 schematically shows a configuration of a communication system according to an embodiment. The communication system shown in FIG. 1 uses two kinds of transmission paths. A wireless transmission path is assumed as one kind of transmission path, and a transmission path formed by a power line is assumed as the other kind of transmission path. The wireless transmission path is not particularly limited to a specific frequency. However, when the wireless transmission path complies with a typical wireless LAN standard such as IEEE802.11 or the like, a 2.4 GHz band or a 5 GHz band may be used. On the other hand, a shortwave band, that is, a frequency band of 3 MHz to 30 MHz is generally used in the transmission path formed by the power line. In this case, from a viewpoint of ease in taking a multipath measure and removing partial interference with another system, an OFDM modulation system is used in each of the transmission paths.

A plurality of terminals 11 and 12 perform communicating operation using these different kinds of transmission paths under control of a base station 21. In an embodiment, a transmission from the base station 21 to the terminal 11 and the terminal 12 is defined as a “downstream” transmission, and a transmission from the terminal 11 and the terminal 12 to the base station 21 is defined as an “upstream” transmission.

The base station 21 is connected to a network 30 via a network interface (not shown). A relatively wide area network such for example as the Internet or an intranet can be assumed as the network 30. The terminal stations 11 and 12 are connected to a computer or the like via a peripheral interface. The terminal stations 11 and 12 communicate with the base station 21 through a wireless transmission path and the transmission path of a power line 40, and access the network 30 via the base station 21.

The terminal stations 11 and 12 and the base station 21 perform communication in the wireless transmission paths via respective antennas 14, 15, and 26. In addition, with respective plugs 17, 18, and 29 of the terminal stations 11 and 12 and the base station 21 connected 4 to outlets 47, 48, and 49 of the power line 40, the terminal stations 11 and 12 and the base station 21 perform communication in the transmission path of the power line 40.

For example, suppose that the base station 21 and the terminal station 11 can simultaneously perform transmission and reception through the two transmission paths, and that the base station 21 and the terminal station 11 perform transmission and reception through the wireless transmission path of the IEEE802.11g standard in the 2.4 GHz band and perform transmission and reception through the transmission path of the power line 40 in the shortwave band. At this time, data can be distributed and simultaneously transmitted and received between the base station 21 and the terminal station 11 through the wireless transmission path in the 2.4 GHz band and the transmission path of the power line 40 in the shortwave band.

A packet communication system is adopted in both of the downstream transmission from the base station 21 to the terminal 11 and the terminal 12 and the upstream transmission from the terminal 11 and the terminal 12 to the base station 21. Specifically, a source station sequentially divides transmitting data, constructs a packet by adding a header including a serial number and other transmission control information to each divided piece of the transmitting data (payload), and appropriately distributes and sends each packet to the transmission path A formed by radio and the transmission path B formed by the power line. On the other hand, a destination source extracts a header part from a received packet, analyzes the header part, and assembles each piece of transmitted data (payload) according to the serial number, thereby reconstructing the original transmitting stream. When there is a missing packet, a control packet such as a NACK or the like is returned to the source station, and thereby a packet retransmission procedure is performed.

When consideration is given to a case where the communication system shown in FIG. 1 is applied to Internet access from within a house, for example, the downstream transmission from the base station 21 to the terminal 11 and the terminal 12 corresponds to the down loading of contents from an information distribution server, and the transmission path is desired to have a high speed. On the other hand, the upstream transmission from the terminal 11 and the terminal 12 to the base station 21 is not desired to have such a high speed, but rather communication quality is important. The upstream transmission is desired to reliably deliver a controlling packet including a response such as an ACK/NACK or the like.

Accordingly, in the communication system according to one embodiment, a data transmitting station such as the base station or the like divides one piece of transmitting data to thereby generate two data packets, and allocates each data packet to the transmission paths A and B and then transmits each data packet. Thus, communication speed is increased as compared with a case of using only one of the transmission paths. The communication system is therefore suitable for applications required of isochronism, such as high-capacity data transmission, moving image streaming and the like.

On the other hand, a data receiving station side such as a terminal station or the like receives the data packets via the transmission paths A and B, and combines the data packets allocated to the respective transmission paths with each other, so that the original transmitting data can be obtained. The terminal station further transmits a packet including a response to the reception of the data packets from the transmission paths A and B simultaneously. Thus, even under a condition where the communication quality of one of the transmission paths deteriorates, the transmission path is complemented by the other transmission path, so that a constant communication quality can be ensured. It is therefore possible to reliably deliver a controlling packet including a response such as an ACK/NACK or the like to the data transmitting station side.

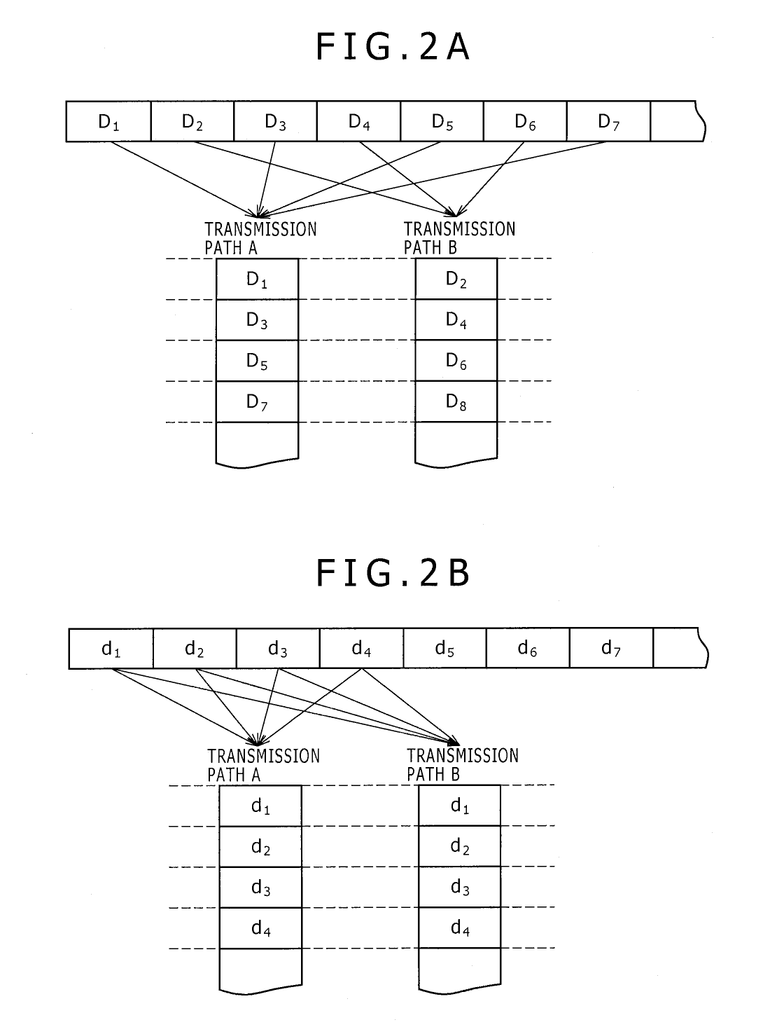

FIG. 2A and FIG. 2B show states in which transmitting packets are distributed to the transmission path A and the transmission path B at each of a time of downstream transmission and a time of upstream transmission.

In FIG. 2A, D1, D2, D3, . . . denote transmitting packets to be transmitted in a down direction, and subscripts indicate a sequence in an original transmitting stream. As shown in FIG. 2A, divided transmitting data is alternately allocated to the transmission path A formed by radio and the transmission path B formed by the power line, and then transmitted. Thus, communication speed is increased as compared with a case of using only one of the transmission paths. The communication system is therefore suitable for applications required of isochronism, such as high-capacity data transmission, moving image streaming and the like.

In FIG. 2B, d1, d2, d3, . . . denote transmitting packets to be transmitted in an up direction, and subscripts indicate a sequence in an original transmitting stream. As shown in FIG. 2B, individual divided pieces of transmitting data are simultaneously transmitted from both of the transmission path A formed by radio and the transmission path B formed by the power line. Thus, even under a condition where the communication quality of one of the transmission paths deteriorates, the transmission path can be complemented by the other transmission path. Therefore, as compared with a case of using only one transmission path, communication quality is improved, and thus a controlling packet such as an ACK/NACK or the like can be reliably delivered to the base station. Of course, when the base station has successfully received packets from both of the transmission paths A and B, it suffices for the base station to perform a receiving process of synthesizing both the packets or selecting the packet received from the transmission path of better communication quality.

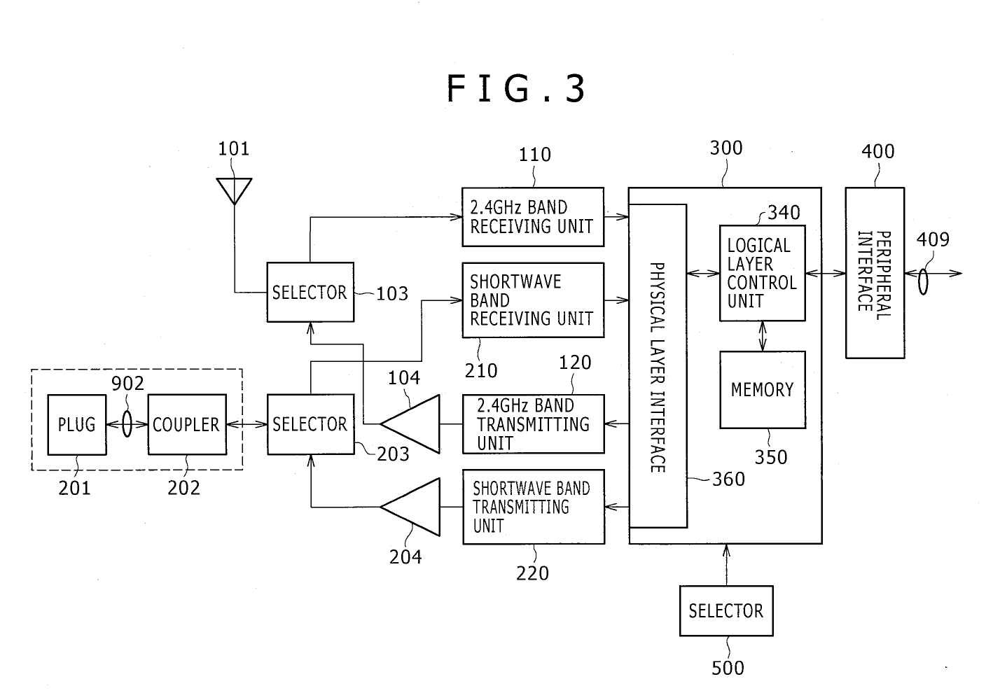

FIG. 3 shows an example of configuration of a communication device that can operate as a base station or a terminal station in the communication system according to embodiment. The communication device has the function of a transmitting device or a receiving device for the 2.4 GHz band as an example of the wireless transmission path and the shortwave band as an example of the transmission path formed by the power line. Specifically, the communication device has an antenna 101, a selector 103, a power amplifier 104, a receiving unit 110, and a transmitting unit 120 for the 2.4 GHz band, and has a plug 201, a coupler 202, a selector 203, a power amplifier 204, a receiving unit 210, and a transmitting unit 220 for the shortwave band. The communication device can simultaneously perform transmission and reception in the 2.4 GHz band and transmission and reception in the shortwave band.

The antenna 101 is used to transmit and receive a high-frequency signal in the 2.4 GHz band. The selector 103 selects the receiving unit 110 or the transmitting unit 120 for the 2.4 GHz band to connect the receiving unit 110 or the transmitting unit 120 to the antenna 101. The selector 203 selects the receiving unit 210 or the transmitting unit 220 for the shortwave band to connect the receiving unit 210 or the transmitting unit 220 to the coupler 202. The plug 201 is a plug of a power cord 902 connected to an outlet of the power line. The coupler 202 is a coupler for coupling-a signal in the shortwave band to the power line.

The receiving units 110 and 210 for the 2.4 GHz band and the shortwave band respectively receive, demodulate, and decode, signals in the 2.4 GHz band and the shortwave band. The transmitting units 120 and 220 for the 2.4 GHz band and the shortwave band respectively encode and modulate signals in the 2.4 GHz band and the shortwave band to transmit the signals. The power amplifiers 104 and 204 are respectively connected to output parts of the transmitting units 120 and 220 for the 2.4 GHz band and the shortwave band. The power amplifiers 104 and 204 amplify the transmitting signals.

A communication control unit 300 mainly performs processing in a logical layer. The communication control unit 300 behaves as either a base station or a terminal station according to an operation of a selector 500. The communication control unit 300 shown in FIG. 3 includes a logical layer control unit 340, a memory 350, and a physical layer interface 360.

The logical layer control unit 340 processes a frame in a MAC (Medium Access Control) sublayer in a data link layer, for example, as a logical layer.

The memory 350 retains work data or the like necessary for the processing by the logical layer control unit 340.

The physical layer interface 360 is an interface for making exchanges with the physical layer realized by the receiving units 110 and 210 and the transmitting units 120 and 220 for the 2.4 GHz band and the shortwave band.

A host interface is used as a peripheral interface 400 when the communication device operates as a terminal station. A host device such as a computer or the like is connected to a port 409 of the host interface. On the other hand, when the communication device operates as a base station, a network interface is used as the peripheral interface 400, and a modem or the like for using the Internet or the like is connected to a port 409 of the network interface.

Incidentally, while one set of the receiving unit 110 and the transmitting unit 120 for the 2.4 GHz band and one set of the receiving unit 210 and the transmitting unit 220 for the shortwave band are provided in the communication device shown in FIG. 3, the spirit of the present application is not limited to this, and does not preclude provision of a plurality of sets of transmitting and receiving units as each of the sets. As for the wireless transmission path, in particular, communication may be performed through a plurality of wireless transmission paths using different frequency bands such for example as the 2.4 GHz band and the 5 GHz band. In addition, communication may be performed through wireless transmission paths using different channels in a same frequency band. Further, communication may be performed through transmission paths having different transfer functions in a same channel.

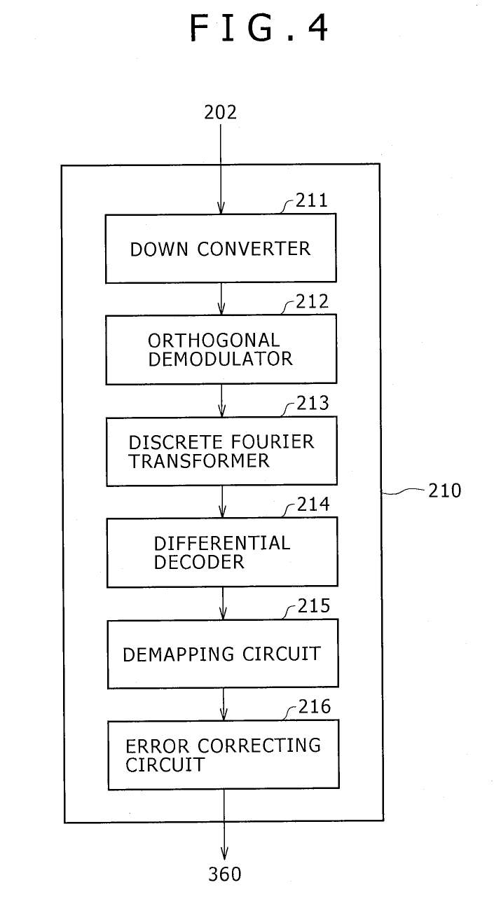

FIG. 4 shows an example of internal configuration of the receiving unit 210 in the communication device shown in FIG. 3.

The receiving unit 210 shown in FIG. 4 assumes an OFDM system. The receiving unit 210 includes a down converter 211, an orthogonal demodulator 212, a discrete Fourier transformer 213, a differential decoder 214, a demapping circuit 215, and an error correcting circuit 216. The receiving unit 210 is configured to convert a high-frequency signal in the shortwave band which signal is received by the coupler 202 into an intermediate signal and perform demodulation and decoding.

The down converter 211 converts a signal in the shortwave band into an intermediate signal in an intermediate frequency band.

The orthogonal demodulator 212 subjects the intermediate signal converted by the down converter 211 to quadrature detection to extract a baseband signal composed of an in-phase signal (I-signal) in phase with the intermediate signal and a quadrature signal (Q-signal) as a quadrature component of the intermediate signal.

The discrete Fourier transformer 213 subjects the baseband signal extracted by the orthogonal demodulator 212 to a fast Fourier transform in an effective symbol duration excluding a guard interval. The discrete Fourier transformer 213 thereby demodulates complex data for each subcarrier.

The differential decoder 214 is used in a PSK (Phase Shift Keying) system, for example. The differential decoder 214 subjects the complex data demodulated by the discrete Fourier transformer 213 to differential decoding.

The demapping circuit 215 demaps the complex data decoded by the differential decoder 214 to extract a data symbol.

The error correcting circuit 216 corrects the data by Viterbi decoding or the like.

The data thus obtained is output to the physical layer interface 360 in the communication control unit 300.

Incidentally, while the above description has been made of the shortwave band receiving unit 210, the 2.4 GHz band receiving unit 110 with a similar configuration also converts a signal in the 2.4 GHz band which signal is received by the antenna 101 into an intermediate signal and performs demodulation and decoding.

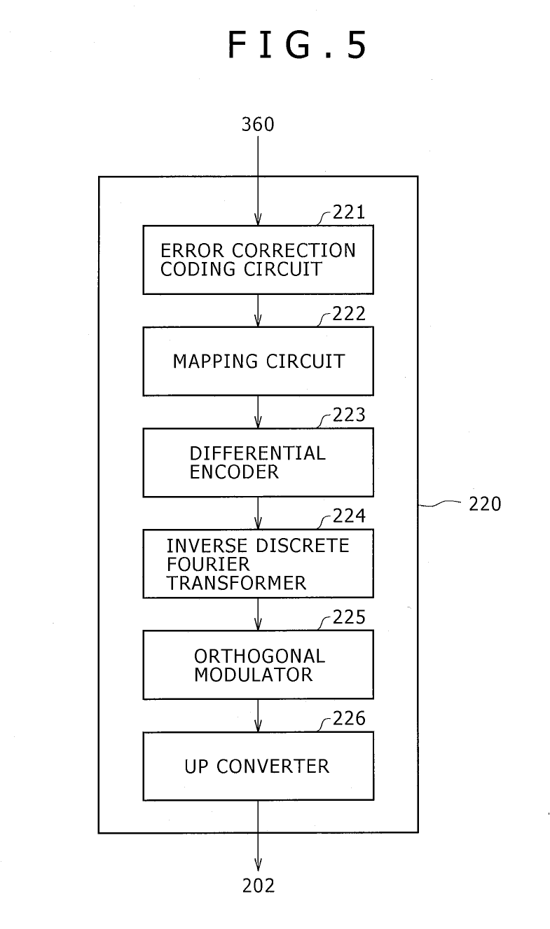

FIG. 5 shows an example of internal configuration of the transmitting unit 220 in the communication device shown in FIG. 3.

The transmitting unit 220 shown in FIG. 3 assumes an OFDM system. The transmitting unit 220 includes an error correction coding circuit 221, a mapping circuit 222, a differential encoder 223, an inverse discrete Fourier transformer 224, a quadrature modulator 225, and an up converter 226. The transmitting unit 220 is configured to encode and modulate data from the physical layer interface 360, convert resulting data into a high-frequency signal, and then output the high-frequency signal to the plug 201.

The error correction coding circuit 221 performs encoding by a convolutional code or the like according to a bit rate. The mapping circuit 222 maps data error-corrected by the error correction coding circuit 221 into a complex data symbol.

The differential encoder 223 subjects the complex data symbol mapped by the mapping circuit 222 to differential encoding, and allocates complex data to each subcarrier.

The inverse discrete Fourier transformer 224 modulates the complex data resulting from the differential encoding by the differential encoder 223 by an inverse Fourier transform, and then outputs a baseband signal (an I-signal 7 and a Q-signal).

The quadrature modulator 225 subjects the baseband signal to quadrature modulation to generate an intermediate signal in a predetermined intermediate frequency band.

The up converter 226 converts the intermediate signal generated by the quadrature modulator 225 into a signal in the shortwave band, and then outputs the signal to the plug 201.

Incidentally, while the above description has been made of the shortwave band transmitting unit 220, the 2.4 GHz band transmitting unit 120 with a similar configuration also encodes and modulates data from the physical layer interface 360, converts resulting data into a signal in the 2.4 GHz band, and then outputs the signal to the antenna 101.

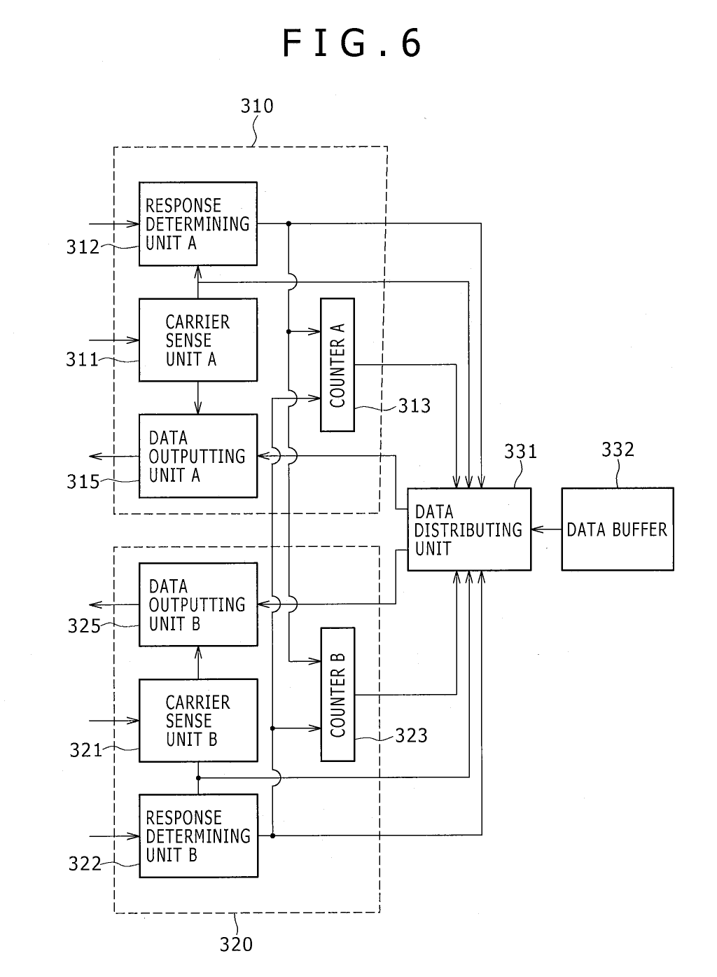

FIG. 6 shows a functional configuration of a data transmission controlling function within the communication control unit 300 of the communication device shown in FIG. 3. The data transmission controlling function shown in FIG. 6 has a data distributing unit 331 for distributing data retained in a data buffer 332, a distribution controlling unit A310 for controlling data distribution in a frequency band A (for example the 2.4 GHz band), and a distribution controlling unit B320 for controlling data distribution in a frequency band B (for example the shortwave band).

The distribution controlling unit A310 includes a carrier sense unit A311, a response determining unit A312, a counter A313, and a data outputting unit A315.

The carrier sense unit A311 reports a state of availability in the frequency band A to the data outputting unit A315, the response determining unit A312, and the data distributing unit 331.

When the carrier sense unit A311 reports that the frequency band A is not available, the data outputting unit A315 does not output data. As a result, when the frequency band B is available, data transmission is performed in only the frequency band B. In this case, once data transmission is started in the frequency band B, it is desirable that control be performed so as not to make a data transfer in the frequency band A this time even when it is later determined that the frequency band A is available. This is to avoid complicating control due to a difference in timing between the data transmissions in the respective frequency bands.

When the carrier sense unit A311 reports that the frequency band A is not available, the response determining unit A312 and the data distributor 331 can perform control for a next data transmission without waiting for an actual response.

The response determining unit A312 determines a response to a previous data transmission in the frequency band A, and supplies a result of the determination to the data distributing unit 331, the counter A313, and a counter B323.

The counter A313 includes a success counter A and a failure counter A (neither is shown). The success counter counts the number of consecutive times that a response to a data transmission in the frequency band A is successfully received consecutively. On the other hand, the failure counter counts the number of consecutive times that data transmitted in the frequency band A fails to be received consecutively.

The counter A313 is supplied with a response determination result from both of the response determining unit A312 and a response determining unit B322. Even in a case where a communication state in one of the frequency bands deteriorates and thus a response cannot be received in the frequency band, conditions of data reception in all the frequency bands can be recognized when a response can be received in at least one of the frequency bands.

The distribution controlling unit B320 also controls data distribution in the frequency band B by a similar configuration to that of the distribution controlling unit A310.

The data distributing unit 331 extracts transmitting data from the data buffer 332, and sequentially distributes the transmitting data to the data outputting unit A315 and a data outputting unit B325. However, a form of data transmission in the frequency band A and the frequency band B is changed according to a state of the counter A313 as follows.

Specifically, when the communication device operates as a base station to perform data transmission to a terminal station in a down direction, in a case where the value of the failure counter indicates a predetermined number or higher and thus the quality of the transmission path is presumed to be lowered in a high-speed transmission mode in which transmitting data is alternately allocated to the frequency band A and the frequency band B as shown in FIG. 2A, the data distributing unit 331 makes a transition to a high-quality transmission mode in which same transmitting data is sent to the frequency band A and the frequency band B simultaneously in a manner as shown in FIG. 2B. In a case where the value of the success counter indicates a predetermined number or higher and thus the quality of the transmission path is presumed to be restored in the high-quality transmission mode, the data distributing unit 331 returns to the high-speed transmission mode. A process of changing a method of distributing transmitting data to each frequency band (or each transmission path) will be explained later in detail.

FIG. 7 shows a functional configuration of a data reception controlling function within the communication control unit 300 of the communication device shown in FIG. 3. The data reception controlling function shown in FIG. 7 has a data combining unit 371 for combining data received in each frequency band and retaining the combined data in a data buffer 372, a combination controlling unit A380 for controlling data combination in the frequency band A (for example the 2.4 GHz band), and a combination controlling unit B390 for controlling data combination in the frequency band B (for example the shortwave band).

The combination controlling unit A380 includes a data determining unit A381 and a response outputting unit A382. The combination controlling unit B390 includes a data determining unit B391 and a response outputting unit B392.

The data determining unit A381 determines a state of data reception in the frequency band A, and then supplies a result of the determination to the data combining unit 371 and the response outputting units A382 and B392. The data determining unit B391 determines a state of data reception in the frequency band B, and then supplies a result of the determination to the data combining unit 371 and the response outputting units A382 and B392.

The response outputting unit A382 outputs the result of the determination of the state of data reception in the frequency band A by the data determining unit A381 and the result of the determination of the state of data reception in the frequency band B by the data determining unit B391 together as a response in the frequency band A. The response outputting unit B392 outputs the result of the determination of the state of data reception in the frequency band A by the data determining unit A381 and the result of the determination of the state of data reception in the frequency band B by the data determining unit B391 together as a response in the frequency band B. That is, the response in each of the frequency bands includes the results of the determination of the states of data reception in all the frequency bands A and B.

When the communication device operates as a terminal station, for example, the contents of the response are included in a control packet such as an ACK/NACK or the like in response to a data packet sent from the base station in a down direction.

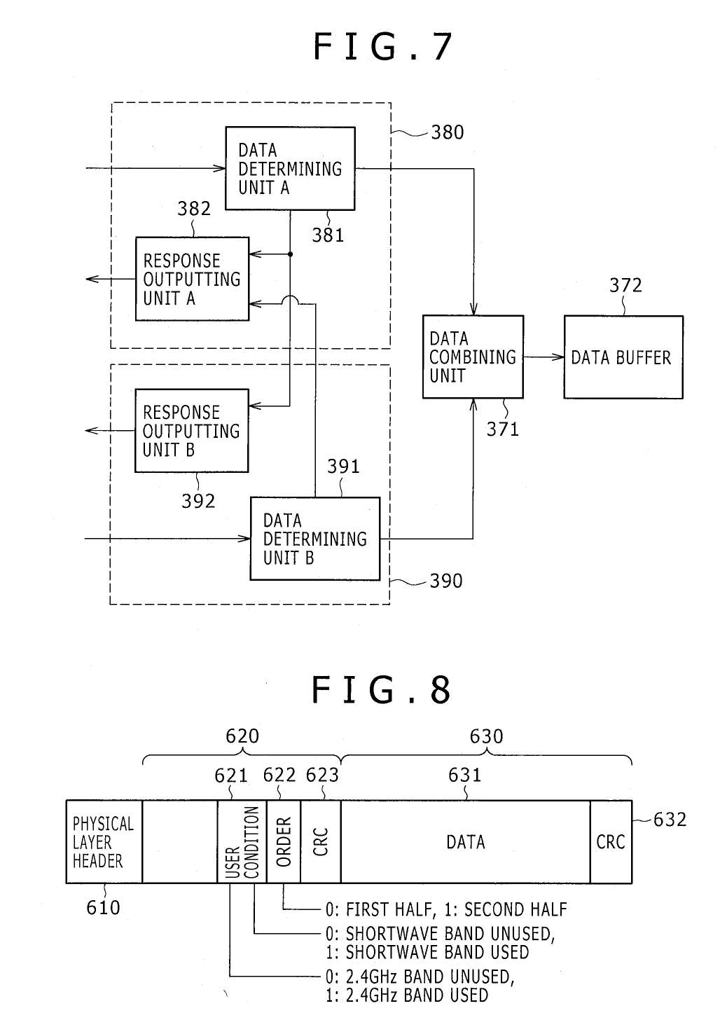

FIG. 8 shows an example of frame configuration of a data packet used in the communication system according to an embodiment. The packet shown in FIG. 8 is used to transmit data in the down direction from the base station to the terminal station, for example. The packet includes a physical layer header 610, a MAC header 620, and a payload 630.

The physical layer header 610 is the header of a PLOP (Physical Layer Convergence Protocol) frame for transmitting information in a PLOP sublayer, for example, as a physical layer. The physical layer header 610 includes fields indicating transmission speed, a modulation system, the length of the PLOP frame and the like.

The MAC header 620 is the header of a MAC frame for transmitting information in a MAC sublayer. The MAC header 620 includes fields indicating a kind of frame, the transmission and reception addresses of the frame, and the like.

The payload 630 is the payload of the MAC frame. The payload 630 includes data 631 and a CRC 632.

In an embodiment, the MAC header 620 in the packet includes fields of a use condition 621, an order 622, and a CRC 623.

The use condition 621 is a field indicating the use condition of each frequency band when the present frame is transmitted. One bit is assigned to each frequency band. For example, a first bit “0” indicates that the 2.4 GHz band is unused, and the first bit “1” indicates that the 2.4 GHz band is used. Similarly, a second bit “0” indicates that the shortwave band is unused, and the second bit “1” indicates that the shortwave band is used. Thereby, the receiving units 110 and 210 that have received the frame can be informed whether there is a frame transmitted simultaneously in the other frequency band.

The order 622 is a field indicating order relation (packet serial number) between pieces of data transmitted simultaneously. For example, when two pieces of data are distributed simultaneously, “0” indicates the first half data, and “1” indicates the second half data. The CRC (Cyclic Redundancy Code) 623 is a cyclic redundancy check code for detecting a data error in the MAC header 620.

At a time of frame transmission, the data distributing unit 331 in the communication control unit 300 generates the use condition 621 and the order 622, and then adds the use condition 621 and the order 622 to the MAC header 620. On the frame receiving side, the data combining unit 371 in the communication control unit 300 stores the data in the data buffer 372 according to the order 622.

For example, when the communication device operates as a base station to transmit high-capacity data or a moving image stream to a terminal station in a down direction, as shown in FIG. 2A, transmitting data is distributed to the frequency bands A and B (or the transmission paths A and B), that is, packets are allocated to the frequency bands A and B (or the transmission paths A and B). Conditions for distributing data will be described in the following.

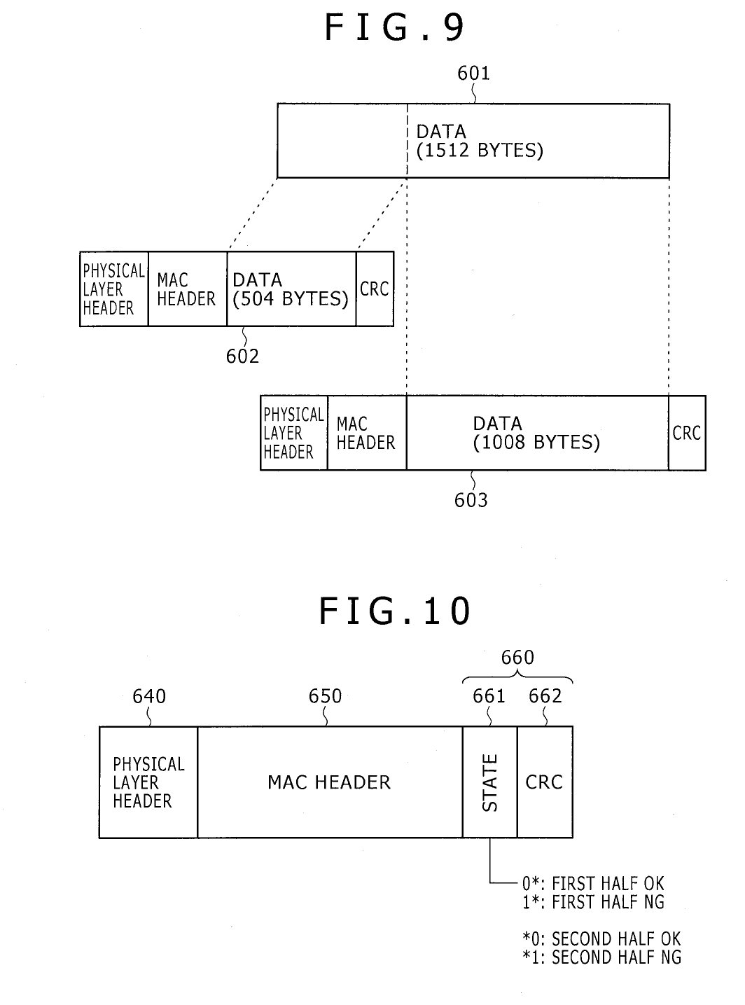

FIG. 9 shows a state in which data to be transferred is divided into two pieces of data, which are distributed to transmitting packets for the respective frequency bands A and B (or the respective transmission paths A and B) and then transmitted.

In an example shown in FIG. 9, transfer data 601 is 1512 bytes. Data included in a data packet 602 is a first half part of 504 bytes of the transfer data 601. Data included in a data packet 603 is a second half part of 1008 bytes of the transfer data 601.

In this case, as a condition for dividing the transfer data 601 and distributing the divided transfer data 601 to the respective frequency bands A and B, the data packet 602 has a modulation mode of QPSK (Quadrature Phase Shift Keying) and a coding rate of ½, and the data packet 603 has a modulation mode of 16 QAM (Quadrature Amplitude Modulation) and a coding rate of ½. According to this condition, the data packet 602 carrying the data of 504 bytes and the data packet 603 carrying the data of 1008 bytes are assigned to the frequency bands A and B, respectively, and then transmitted. Thereby times required for the transmission in the respective frequency bands A and B are equal to each other.

Letting m1 and m2 be the numbers of bits for the modulation systems of the first half part and the second half part, respectively, obtained by dividing the data to be transferred, and letting r1 and r2 be the coding rates of the first half part and the second half part, respectively, the transmission times of both the parts are equal to each other when the data is divided according to the following ratio and then distributed to the frequency, bands A and B

m1×r1:m2×r2

In the above-describe example 2×(½)4×(½)=1:2, and thus the ratio between the first half part and the second half part is 1 to 2.

As another example when the first half part has a modulation mode of BPSK and coding rate of ½, and the second half part has a modulation mode, of 64 QAM and a coding rate of ¾, a ratio between the first half part and the second half part obtained by dividing the data to be transferred is 1×(½):6×(¾)=1:9.

By thus distributing the data to each of the frequency bands A and B, the times required to transmit the data packets assigned to each of the frequency bands can be made equal to each other.

Incidentally, detailed calculation when even the MAC header and the CRC of the data are taken into consideration is as follows. However, suppose that the modulation mode of the physical layer header is not varied and is an identical modulation mode in each transmitting packet. Supposing that the MAC header is 30 bytes, the CRC of the data is 4-bytes, the number of bytes of the transmitting data is d, the numbers of bytes of the data of the first half part and the second half part are d1 and d2, respectively, the numbers of bits for the modulation systems of the first half part and the second half part are m1 and m2, respectively, and the coding rates of the first half part and the second half part are r1 and r2, respectively, the following equation holds from the condition that the data transmission times of the first half part and the second half part be made equal to each other.

$$( 30 + d 1 + 4 ) / ( m 1 \times r 1 ) = ( 30 + d 2 + 4 ) / ( m 2 \times r 2 ) d = d 1 + d 2$$

This is solved for d1 and d2 as follows.

$$\begin{matrix}d 1 = d \times ( m 1 \times r 1 ) / ( m 1 \times r 1 + m 2 \times r 2 ) + 34 \times \\ ( m 1 \times r 1 - m 2 \times r 2 ) / ( m 1 \times r 1 + m 2 \times r 2 ) \\ d 2 = d \times ( m 2 \times r 2 ) / ( m 1 \times r 1 + m 2 \times r 2 ) + 34 \times \\ ( m 2 \times r 2 - m 1 \times r 1 ) / ( m 1 \times r 1 + m 2 \times r 2 )\end{matrix}$$

When information to be transmitted depending on the modulation mode is included in a part of the physical layer header and the packets are defined, a value at a position corresponding to “34” of a second term on a right side of both the above equations is changed appropriately. Of course, when the data length of the MAC header is different, the value at the position corresponding to “34” is changed appropriately.

FIG. 10 shows an example of frame configuration of a control packet used to return a response in the communication system according to an embodiment. The response packet shown in FIG. 10 is for example returned from a terminal station that has received a data packet to a base station as a data source. The response packet includes a physical layer header 640, a MAC header 650, and a payload 660. The physical layer header 640 is the header of a PLOP frame for transmitting information in a PLOP sublayer. The MAC header 650 is the header of a MAC frame for transmitting information in a MAC sublayer. Thus, the physical layer header 640 and the MAC header 650 are similar to the physical layer header 610 and the MAC header 620 of the data packet shown in FIG. 8.

The response packet shown in FIG. 10 includes respective fields of a state 661 and a CRC 662 in the payload 660. The state 661 is a field indicating a state of reception of distributed data. The CRC 662 is a cyclic redundancy check code for detecting a data error in the MAC header 650 and the payload 660.

The state 661 includes all states of reception of the data distributed and transmitted simultaneously. Therefore even a response packet in the frequency band A, for example, includes the states of reception in not only the frequency band A but also the frequency band B. Thus, the state 661 includes information corresponding to the number of pieces of the distributed data. When the data is divided into two pieces of data and the two pieces of data are transmitted, the field is for example composed of two bits. The first bit can indicate the state of reception of the first half part, and the second bit can indicate the state of reception of the second half part. Specifically, when the reception of the first half part succeeds, the first bit is “0”, and when the reception of the first half part fails, the first bit is “1”. Similarly, when the reception of the second half part succeeds, the second bit is “0”, and when the reception of the second half part fails, the second bit is “1”.

The state 661 of the response packet is generated by the response outputting units A352 and B362 on the basis of results of determination of the data determining units A351 and B361 in the communication control unit 300 of the terminal station that has received the data. The response packet is returned to the base station as the data source. The response determining units A312 and B322 in the base station as the data source determine the state 661.

Operations of a terminal station and a base station in the communication system according to an embodiment will next be described with reference to drawings.

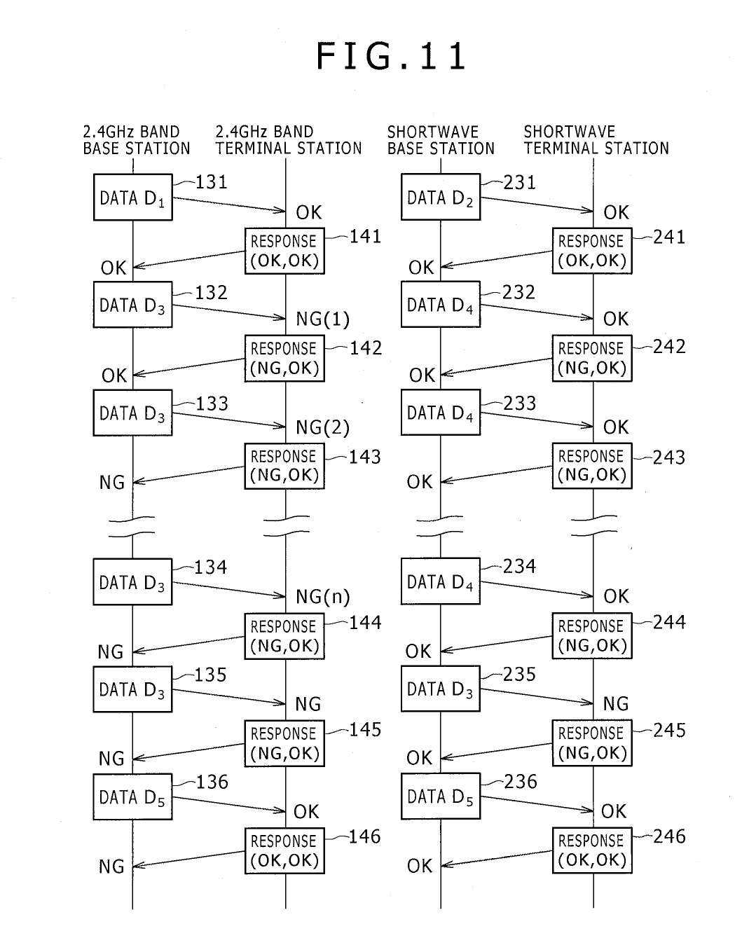

FIG. 11 shows an example of a communicating operation sequence in which the transmission of data packets and the returning of response packets in response to the data packets are performed between the terminal station and the base station in the communication system according to an embodiment. In this case, suppose that data is transmitted from the base station to the terminal station using a transmission path A formed by radio using a frequency band A (for example the 2.4 GHz band) and a transmission path B formed by a power line using a frequency band B (for example the shortwave band). In the figure, processing by the base station in the frequency band A is represented as “base station A”, processing by the base station in the frequency band B is represented as “base station B”, processing by the terminal station in the frequency band A is represented as “terminal station A”, and processing by the terminal station in the frequency band B is represented as “terminal station B”.

FIG. 11 shows an example of an operation sequence in a case where the base station initially performs data transmission processing that divides data to be transferred into a first half part and a second half part and which assigns these parts to the respective frequency bands A and B, and then the base station stops dividing the transmitting data and switches to a high-quality transmission mode in which same data is simultaneously transmitted from the frequency bands A and B because degradation of communication quality in one of the bands becomes manifest during the data transmission processing.

First, the base station divides data to be transferred into data D1 and data D2. In dividing the data, the transmission times of the data D1 and the data D2 are set equal to each other with the modulation systems and the coding rates in the respective transmission paths A and B taken into consideration (the same is true in the following). Then, the data D1 is assigned, to the frequency band A, and the data D2 is assigned to the frequency band B. The data D1 and the data D2 are transmitted simultaneously and in parallel with each other (131 and 231).

Thus, the data to be transferred is divided into the first half part and the second half part, and the parts are assigned to the respective transmission paths A and B and then transmitted. Therefore communication speed is increased as compared with a case of using only one of the transmission paths or a case of sequentially transmitting same data in both the transmission paths.

“OK” or “NG” entered on the right side of the terminal station A and the terminal station B in FIG. 11 denotes a “success” or a “failure”, respectively, as a state of data reception. In the example shown in FIG. 11, the terminal station has succeeded in receiving the data D1 and the data D2 from the respective transmission paths A and B. Then, the terminal station returns states of reception in the frequency band A and the frequency band B as responses to the base station through both the frequency band A and the frequency band B simultaneously (141 and 241).

Thus, because the response is transmitted from the transmission paths A and B simultaneously, even when the quality of one of the transmission paths deteriorates, the transmission path is complemented by the other transmission path, so that communication quality is improved. It is therefore possible to reliably deliver the response to the base station.

“OK” or “NG” entered on the left side of the base station A and the base station B in FIG. 11 denotes a “success” or a “failure”, respectively, as a state of response reception. In the example shown in FIG. 11, the base station has succeeded in receiving the responses 141 and 241.

Next, the base station divides data to be transferred next into data D3 and data D4, assigns the data D3 to the frequency band A and the data D4 to the frequency band B, and transmits both the data D3 and the data D4 simultaneously and in parallel with each other (132 and 232).

Suppose here that the terminal station has succeeded in receiving the data D4 but has failed to receive the data D3. The terminal station returns states of reception in the frequency band A and the frequency band B as responses to the base station through both the frequency band A and the frequency band B simultaneously (142 and 242). Suppose that the base station has succeeded in receiving the responses 142 and 242.

The base station analyzes the responses 142 and 242 received in the respective frequency bands A and B. The base station thereby determines that the terminal station has failed to receive the data D3. Accordingly, the data distributing unit 331 in the base station assigns the data D3 to the frequency band A and the data D4 to the frequency band B and then transmits both of the data D3 and the data D4 simultaneously and in parallel with each other again (133 and 233).

Suppose that also at the time of the data retransmission, the terminal station has succeeded in receiving the data D4 but has failed to receive the data D3. The terminal station returns states of reception in the frequency band A and the frequency band B as responses to the base station through both the frequency band A and the frequency band B simultaneously (143 and 243). Suppose here that the base station has succeeded in receiving the response 243 but has failed to receive the response 143.

The response 243 includes not only the state of reception in the frequency band B but also the state of reception in the frequency band A. Thus, the data distributing unit 331 in the base station recognizes that the data D3 has failed to be transmitted, and tries transmitting the data D3 and the data D4 again.

Suppose here that a state of communication in the frequency band A deteriorates and thus the retransmission of the data D3 and the data D4 has not succeeded. Suppose that even though the data distributing unit 331 in the base station has transmitted the data D3 and the data D4 n consecutive times (134 and 234), the terminal station also at this time has succeeded in receiving the data D4 but has failed to receive the data D3.

The failure counter A of the counter A313 on the base station side counts the number of consecutive times that the data D3 is not normally received in the frequency band A. When a notification that the data D3 has not been received is provided by a response 244 and it is thus determined that the reception of the transmitting data in the frequency band A has failed n consecutive times, it can be presumed that the state of communication in the frequency band A has deteriorated.

In such a case, the same data as in the frequency band B is transmitted in the frequency band A. Then, the data D3 that has not been correctly delivered is transmitted in the frequency band B (235), and is received successfully. Even though a response 145 to a transmission 235 of the data D3 fails to be received in the frequency band A, a response 245 to the transmission 235 of the data D3 is successfully received in the frequency band B. The base station thus recognizes that the transmission 235 of the data D3 has succeeded.

Thus, the data to be transferred is not divided into the transmission paths A and B, and the same data is transmitted from the transmission paths A and B simultaneously. Thus, even when the quality of one of the transmission paths deteriorates, the transmission path is complemented by the other transmission path, so that communication quality is improved. It is therefore possible to reliably deliver the data to the terminal station.

Because the processing of dividing data into the transmission paths A and B is thereafter stopped, same data as next data D5 and subsequent data is transmitted in the frequency band A and the frequency band B simultaneously.

In the example shown in FIG. 11, the data D5 (236) is not delivered correctly in the frequency band B, but the data D5 (136) transmitted in the frequency band A is delivered correctly. Therefore retransmission does not occur. Thus, when the quality of one of the bands has deteriorated, same data is transmitted in both bands simultaneously, so that transmission quality can be enhanced.

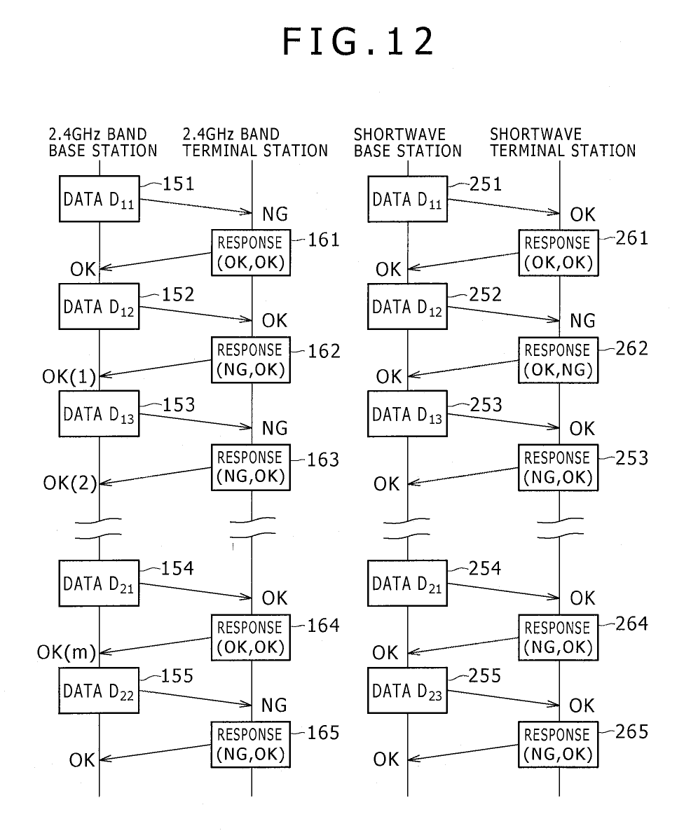

FIG. 12 shows another example of a communicating operation sequence in which the transmission of data packets and the returning of response packets in response to the data packets are performed between the terminal station and the base station in the communication system according to an embodiment. The figure shows an example of an operation sequence in which the base station returns to the high-speed transmission, mode as communication quality is restored after the base station has stopped dividing transmitting data and has once changed to the high-quality transmission mode because degradation of communication quality in one band became manifest.

In this case, suppose that as in the last state in FIG. 11, the base station makes a transition to the high-quality transmission mode, and performs data transmission without dividing transmitting data, that is, without assigning different pieces of data to the respective frequency bands A and B. Thus, the base station transmits data D1i in the frequency band A and the frequency band B simultaneously. Suppose that the terminal station succeeds in receiving the data D11 in the frequency band B. The terminal station returns states of reception in the frequency band A and the frequency band B as response to the base station through both the frequency band A and the frequency band B simultaneously (161 and 261). Suppose that the base station has normally received the response 261 through the frequency band B but has failed to receive the response 161 through the frequency band A.

Next, the base station transmits data D12 in the frequency band A and the frequency band B simultaneously. Suppose that the terminal station succeeds in receiving the data D12 in the frequency band A. The terminal station returns states of reception in the frequency band A and the frequency band B as responses to the base station through both the frequency band A and the frequency band B simultaneously (162 and 262). Suppose that the base station has succeeded in receiving the responses 162 and 262.

Further, the base station transmits data D13 in the frequency band A and the frequency band B simultaneously. Suppose that the terminal station succeeds in receiving the data D13 in the frequency band B. The terminal station returns states of reception in the frequency band A and the frequency band B as responses to the base station through both the frequency band A and the frequency band B simultaneously (163 and 263). Suppose that the base station has succeeded in receiving the responses 163 and 263.

A similar process is repeated. Suppose that the base station transmits data D21 in the frequency band A and the frequency band B simultaneously, and that the base station successfully receives responses 164 and 264 to the transmission of the data D21.

The success counter A of the counter A313 in the base station counts the number of times that a response is received normally in the frequency band A. When it is determined that the response 164 is received normally and that response reception in the frequency band A has succeeded m consecutive times, it can be presumed that the state of communication in the frequency band A is improved. Then, the base station thereafter transfers data formed by the division. Thus, next data D22 and data D23 are distributed to the frequency band A and the frequency band B, and transmitted simultaneously 155 and 255).

In the example shown in FIG. 12, the data D12 (252) is not correctly delivered to the terminal station in the frequency band B, but the data D12 (152) transmitted in the frequency band A is correctly delivered to the terminal station. Therefore retransmission does not occur. Thus, when the quality of one of the bands has deteriorated, same data is transmitted in both bands simultaneously, so that transmission quality can be enhanced. In other words, even when the quality of one of the bands has deteriorated significantly, transmission may succeed, and thus the transmission does not need to be stopped.

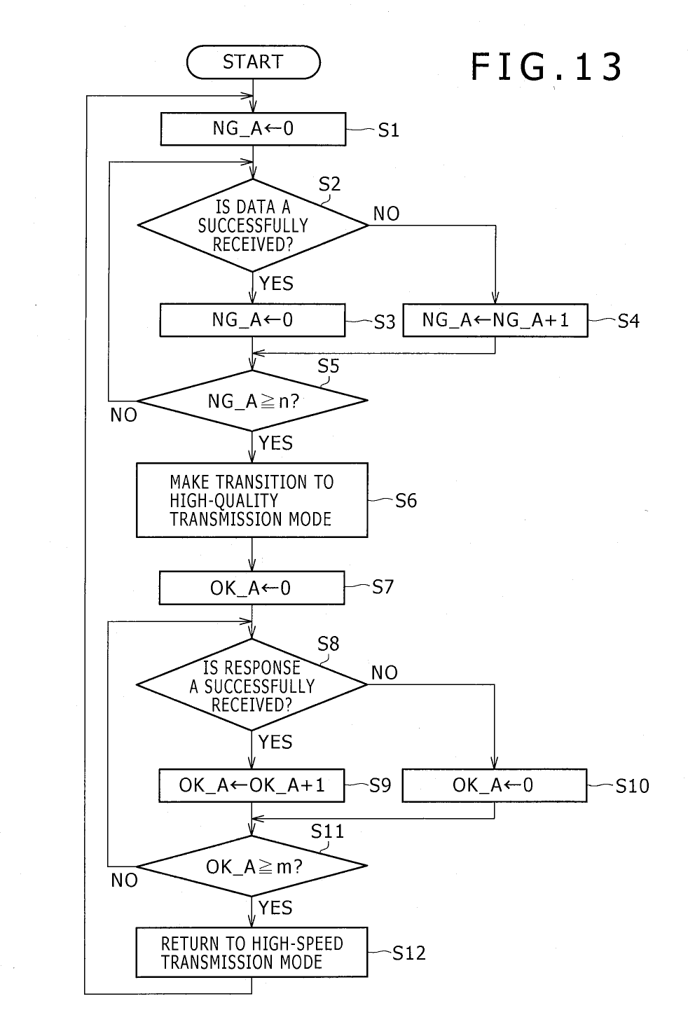

FIG. 13 shows a processing procedure for the communication device according to an embodiment to operate as a base station in the form of a flowchart.

As already described, the base station side observes changes in communication quality in each of the frequency bands A and B on the basis of results of counting the number of times that response reception has succeeded and the number of times that response reception has failed. In FIG. 13, the success counter A in the counter A313 is denoted by OK A, and the failure counter A in the counter A313 is denoted by NGA.

In the high-speed transmission mode, the failure counter A (NG_A) is cleared to zero in advance (step S1). In this case, when the reception of transmitted data in the frequency band A succeeds (Yes in step S2), the failure counter A is cleared to zero (step S3). When the reception of transmitted data in the frequency band A fails (No in step S2), the failure counter A is incremented by one (step S4).

When the failure counter A indicates a predetermined number “n” or higher as a result of consecutive failures in the reception of the transmitted data (Yes in step S5), it is presumed that communication quality is lowered. Therefore, the high-speed transmission mode in which transfer data is divided, distributed to the frequency bands A and B, and then sent is stopped (step S6), and a transition is made to the high-quality transmission mode, in which same data is transmitted in the frequency band A and the frequency band B.

On the other hand, in a state of data transmission in the frequency band A being performed successfully (transmission mode) (No in step S5), the determination in steps S2 to S4 described above is repeated.

In the high-quality transmission mode, the success counter A (OK A) is cleared to zero in advance (step S7). Even in a state of high-speed transmission being stopped, in which high-speed transmission transfer data is divided, distributed to the frequency bands A and B, and then transmitted, the terminal station continues transmitting a response also in the frequency band A.

When a response is received successfully in the frequency band A (Yes in step S8), the success counter A is incremented by one (step S9). On the other hand, when a response fails to be received in the frequency band A (No in step S8), the success counter. A is cleared to zero (step S10).

When the success-counter A indicates a predetermined number “m” or higher as a result of consecutive successes in the reception of transmitted data (Yes in step S11), the high-speed transmission mode is thereafter resumed (step S12).

On the other hand, when the transmission of data in the frequency band A does not succeed consecutively, and high-speed transmission is stopped (No in step S11), the determination in steps S8 to S11 described above is repeated.

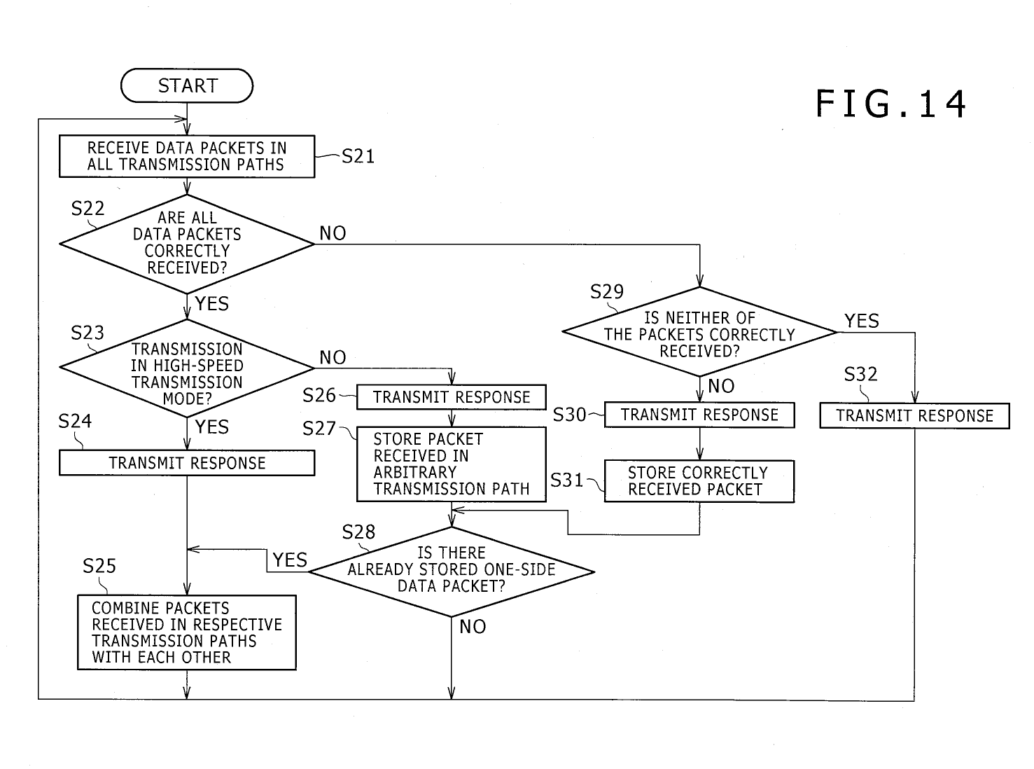

FIG. 14 shows a processing procedure for the communication device according to an embodiment to operate as a terminal station in the form of a flowchart.

The terminal station attempts to receive data packets from the base station in the two transmission paths using the frequency bands A and B (step S21).

Next, the terminal station checks whether the data packets have been received correctly in the respective transmission paths (step S22). This check can be performed using the CRC given to the data packets. When the data packets cannot be received correctly in both the two transmission paths (No in step 22), the process proceeds to step S29.

On the other hand, when the data packets have been received correctly in both the two transmission paths (Yes in step S22), a check is performed next to determine whether the data packets received in the respective transmission paths have been transmitted in the high-speed transmission mode with the data divided for each of the transmission paths, or whether the data packets received in the respective transmission paths have been transmitted in the high-quality transmission mode with the same data in each of the transmission paths (step S23).

When the data packets have been transmitted from the base station in the high-quality transmission mode, that is, when the data packets received in the respective transmission paths are the same data (No in step S23), the process proceeds to step S26.

On the other hand, when the data packets have been transmitted from the base station in the high-speed transmission mode, that is, when the data packets received by the terminal station through the respective transmission paths are not the same data (Yes in step S23), a response indicating that the two data packets have been received correctly is returned to the base station side (step S24).

Then, the data packets received in the respective transmission paths are combined with each other, whereby data before being divided is reconstructed, and then the data is transferred to a higher level application (step

S25). Thereafter the process returns to step S21 to repeat the same process as described above.

When the data packets have both been received correctly through the two transmission paths and the data packets were transmitted from the base station in the high-quality transmission mode, that is, when the data packets received through the respective transmission paths are the same data (No in step S23), a response indicating that the two data packets have been received correctly is returned to the base station side (step S26).

Then, the terminal station stores an arbitrary one of the two received data packets, and discards the other (step S27). Alternatively, the two data packets may be synthesized.

Next, a check is performed to determine whether there is an already stored data packet on one side (step S28). When there is an already stored data packet on one, side (Yes in step S28), the process proceeds to step S25, where the two data packets received in the respective transmission paths are combined with each other and transferred to the higher level application (step S25). Thereafter the process returns to step S21 to repeat the same process as described above. When there is not an already stored data packet on one side (No in step S28), the process directly returns to step S21 to repeat the sane process as described above.

When the data packets cannot be received correctly in both the two transmission paths (No in step S22), a check is further performed to determine whether neither of the data packets has been received correctly in the two transmission paths (step S29).

When the data packet has been received correctly in one of the transmission paths (No in step S29), a response corresponding to error conditions of the two data packets is returned to the base station on the transmitting side (step S30). The correctly received data packet of the two data packets is stored (step S31). Thereafter the process returns to step S21 to repeat the same process as described above.

On the other hand, when neither of the data packets has been received correctly in the two transmission paths (Yes in step S29), a response indicating that neither of the data packets has been received is returned to the base station (step S32). Thereafter the process returns to step S21 to repeat the same process as described above.

Incidentally, when a response is returned from the receiving side in each of the above-described steps S24, S26, S30, and S32, the same information is carried in the two transmission paths.

The present application has been explained above in detail with reference to specific embodiments thereof. It is evident, however, that modifications and substitutions in the embodiments may be made by those skilled in the art without departing from the spirit of the present application.

In the present specification, description has been made centering on embodiments applied to a communication system using both a transmission path formed by radio and a transmission path formed by a power line. However, the spirit of the present application is not limited to this. It is needless to say that the present application can be similarly realized in various communication systems using a plurality of transmission paths independent of each other, such for example as a communication system based on a plurality of transmission paths using different frequency bands.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes Land modifications be covered by the appended claims.

The invention is claimed as follows:

1. A communication system in which communicating stations are interconnected via a first transmission path and a second transmission path, said communication system comprising:
a data transmitting station for dividing one piece of transmission data to generate two data packets, assigning the data packets to said first transmission path and said second transmission path, and transmitting each data packet; and
a data receiving station for receiving the data packets from said data transmitting station via said first transmission path and said second transmission path, obtaining the original transmission data by combining the data packets assigned to the respective transmission paths with each other, and transmitting a packet including a response to reception of the data packets from said first transmission path and said second transmission path simultaneously.

2. The communication system according to claim 1, wherein said data transmitting station determines communication quality of each transmission path, and performs data packet transmission processing in one of operation modes according to a result of the determination, said operation modes being a high-speed transmission mode in which transmitting packets are assigned to respective transmission paths and transmitted and a high-quality transmission mode in which a same transmitting packet is simultaneously transmitted to each transmission path.

3. The communication system according to claim 2, wherein said data transmitting station determines the response returned from said data receiving station, and makes a transition to data packet transmitting operation in said high-quality transmission mode according to one of a fact that frequency of failure to receive a response to transmission of a data packet has exceeded a predetermined reference and a fact that response reception has failed a predetermined number of consecutive times.

4. The communication system according to claim 3, wherein said data transmitting station returns to transmitting operation in said high-speed transmission mode according to one of a fact that frequency of failure to receive a response to transmission of a data packet has become lower than a predetermined reference and a fact that response reception has succeeded a predetermined number of consecutive times.

5. The communication system according to claim 1, wherein said first transmission path is a transmission path formed by radio, and said second transmission path is a transmission path formed by a power line.

6. A communication device for transmitting data to another communicating station, said communication device and said other communicating station being interconnected via a first transmission path and a second transmission path, said communication device comprising:
first communicating, means for performing communication using said first transmission path;
second communicating means for performing communication using said second transmission path; and
communication controlling means for controlling communicating operation of said first communicating means and said second communicating means;
wherein in transmitting data to said other communicating station, said communication controlling means divides the transmission data to generate data packets, assigns the data packets to said first transmission path and said second transmission path, and transmits the data packets using said first communicating means and said second communicating means, and
in receiving a response to transmission of the data from said other communicating station, said communication controlling means receives a response packet transmitted to said first transmission path and said second transmission path simultaneously, using said first communicating means and said second communicating means.

7. The communication device according to claim 6, further comprising determining means for determining communication quality of said first transmission path and said second transmission path,
wherein said communication controlling means performs data packet transmission processing in tone of operation modes according to a result of the determination, said operation modes being a high-speed transmission mode in which transmitting packets are assigned to respective transmission paths and transmitted and a high-quality transmission mode in which a same transmitting packet is simultaneously transmitted to each transmission path.

8. The communication device according, to claim 7, wherein said determining means determines the communication quality of said first transmission path and said second transmission path on a basis of the response received from said other communicating station by said first communicating means and said second communicating means, and
said communication controlling means makes a transition to data packet transmitting operation in said high-quality transmission mode according to one of a fact that frequency of failure to receive a response to transmission of a data packet has exceeded a predetermined reference and a fact that response reception has failed a predetermined number of consecutive times.

9. The communication device according to claim 8, wherein said communication controlling means returns to transmitting operation in said high-speed transmission mode according to one of a fact that frequency of failure to receive a response to transmission of a data packet has become lower than a predetermined reference and a fact that response reception has succeeded a predetermined number of consecutive times.

10. The communication device according to claim 6, wherein said first transmission path is a transmission path formed by radio, and said second transmission path is a transmission path formed by a power line.

11. A communication device for receiving data from another communicating station, said communication device and said other communicating station being interconnected via a first transmission path and a second transmission path, said communication device comprising:
first communicating means for performing communication using said first transmission path;
second communicating means for performing communication using said second transmission path; and
communication controlling means for controlling communicating operation of said first communicating means and said second communicating means;
wherein in receiving data from said other communicating station, said communication controlling means receives respective data packets assigned to said first transmission path and said second transmission path and transmitted, using said first communicating means and said second communicating means, and combines the data to reconstruct original transmission data, and
said communication controlling means transmits a response to reception of the data packets to said first transmission path and said second transmission path simultaneously using said first communicating means and said second communicating means.

12. The communication device according to claim 11, wherein said other communicating station transmits the data packets in one of operation modes, said operation modes being a high-speed transmission mode in which transmitting packets are assigned to respective transmission paths and transmitted and a high-quality transmission mode in which a same transmitting packet is simultaneously transmitted to each transmission path, and
said communications controlling means determines in which of said transmission modes the received data packets have been transmitted, reconstructs the original transmission data by combining the data packets received from said first transmission path and said second transmission path using said first communicating means and said second communicating means in the high-speed transmission mode, and reconstructs the original transmission data from one of the data packets that is received successfully from one of said first transmission path and said second transmission path using one of said first communicating means and said second communicating means in the high-quality transmission mode.

13. The communication device according to claim 11, wherein said first transmission path is a transmission path formed by radio, and said second transmission path is a transmission path formed by a power line.

14. A communication method of a communication device, for transmitting data to another communicating station, said communication device and said other communicating station being interconnected via a first transmission path and a second transmission path, said communication method comprising the steps of:
transmitting data to said other communicating station, dividing the transmission data to generate data packets, assigning the data packets to said first transmission path and said second transmission path, and transmitting the data packets; and
receiving a response packet in response to transmission of the data, the response packet being transmitted from said other communicating station to said first transmission path and said second transmission path simultaneously.

15. The communication method according to claim 14, further comprising a determining step of determining communication quality of said first transmission path and said second transmission path,
wherein said data packet transmitting step performs data packet transmission processing in one of operation modes according to a result of the determination, said operation modes being a high-speed transmission mode in which transmitting packets are assigned to respective transmission paths and transmitted and a high-quality transmission mode in which a same transmitting packet is simultaneously transmitted to each transmission path.

16. The communication method according to claim 15, wherein said determining step determines the communication quality of said first transmission path and said second transmission path on a basis of a response received from said other communicating station, and
said data packet transmitting step makes a transition to data packet transmitting operation in said high-quality transmission mode according to one of a fact that frequency of failure to receive a response to transmission of a data packet has exceeded a predetermined reference and a fact that response reception has failed a predetermined number of consecutive times.

17. The communication method according to claim 16, wherein said data packet transmitting step returns to transmitting operation in said high-speed transmission mode according to one of a fact that frequency of failure to receive a response to transmission of a data packet has become lower than a predetermined reference and a fact that response reception has succeeded a predetermined number of consecutive times.

18. The communication method according to claim 14, wherein said first transmission path is a transmission path formed by radio, and said second transmission path is a transmission path formed by a power line.

19. A communication method of a communication device, for receiving data from another communicating station, said communication device and said other communicating station being interconnected via a first transmission path and a second transmission path, said communication method comprising the steps of:
receiving respective data packets assigned to said first transmission path and said second transmission path and transmitted, and combining the data to reconstruct original transmission data; and
transmitting a response to reception of the data packets to said first transmission path and said second transmission path simultaneously.

20. The communication method according to claim 19, wherein said other communicating station transmits the data packets in one of operation modes, said operation modes being a high-speed transmission mode in which transmitting packets are assigned to respective transmission paths and transmitted and a high-quality transmission mode in which a same transmitting packet is simultaneously transmitted to each transmission path, and
said data packet receiving step determines in which of said transmission modes the received data packets have been transmitted, reconstructs the original transmission data by combining the data packets received from said first transmission path and said second transmission path in the high-speed transmission mode, and reconstructs the original transmission data from one of the data packets that is received successfully from one of said first transmission path and said second transmission path in the high-quality transmission mode.

21. The communication method according to claim 19, wherein said first transmission path is a transmission path formed by radio, and said second transmission path is a transmission path formed by a power line.

22. A communication device for transmitting data to another communicating station, said communication device and said other communicating station being interconnected via a first transmission path and a second transmission path, said communication device comprising:
a first communicating section performing communication using said first transmission path,
a second communicating section performing communication using said second transmission path; and
a communication controlling section controlling communicating operation of said first communicating section and said second communicating section;
wherein in transmitting data to said other communicating station, said communication controlling section divides the transmission data to generate data packets, assigns the data packets to said first transmission path and said second transmission path, and transmits the data packets using; said first communicating section and said second communicating section, and
in receiving a response to transmission of the data from said other communicating station, said communication controlling section receives a response packet transmitted to said first transmission path and said second transmission path simultaneously, using said first communicating section and said second communicating section.

23. A communication device for receiving data from another communicating station, said communication device and said other communicating station being interconnected via a first transmission path and a second transmission path, said communication device comprising:
a first communicating section performing communication using said first transmission path;
a second communicating section performing communication using said second transmission path; and
a communication controlling section controlling communicating operation of said first communicating section and said second communicating section;
wherein in receiving data from said other communicating station, said communication controlling section′ receives respective data packets assigned to said first transmission path and said second transmission path and transmitted, using said first communicating section and said second communicating section, and combines the data to reconstruct original transmission data, and
said communication controlling section transmits a response to reception of the data packets to said first transmission path and said second transmission path simultaneously using said first communicating section and said second communicating section.
